(19) United States
(12) Patent Application Publication
(10) Pub. No.: US 2025/0252288 A1
(43) Pub. Date: Aug. 7, 2025

(54) SYSTEMS AND METHODS FOR A TIME SERIES FORECASTING TRANSFORMER NETWORK

(71) Applicant: Salesforce, Inc., San Francisco, CA (US)

(72) Inventors: Gerald Woo, Singapore (SG); Chenghao Liu, Singapore (SG); Doyen Sahoo, Singapore (SG)

(21) Appl. No.: 18/658,873

(22) Filed: May 8, 2024

Related U.S. Application Data
(60) Provisional application No. 63/548,681, filed on Feb. 1, 2024.

(51) Int. Cl. G06N 3/045; G06Q 10/04

(52) U.S. Cl. CPC G06N 3/045; G06Q 10/04

(57) ABSTRACT

Embodiments described herein provide a Transformer architecture for time series data forecasting. Specifically, the Transformer based time series model may be built on a transformer architecture having one or more multi patch size projection layers in the encoder and the decoder, and an any-variate attention module. The Transformer based time series model may receive multivariate time series and consider all variates as a single sequence. Patches of the input are subsequently projected into vector representations via a multi patch size input projection layer. The output tokens of forecasted time series data are then decoded via the multi patch size output projection layers in the parameters of the mixture distribution.

### CROSS REFERENCE

The instant application is a nonprovisional of and claims priority under 35 U.S.C. 119 to U.S. provisional application No. 63/548,681, filed Feb. 1, 2024, which is hereby expressly incorporated by reference herein in its entirety.

### TECHNICAL FIELD

The embodiments relate generally to neural networks and machine learning systems, and more specifically to a time series forecasting Transformer neural network.

### BACKGROUND

Time series data is widely used in different applications, such as weather forecasting, financial analytics with stock market dynamics, and/or the like. Existing neural network models may be trained to predict time-series data, e.g., predicting the weather for a future time period given the past weather data. However, for different types of time-series data, the prediction model often needs to be re-trained with different datasets of different types of time-series data, e.g., each time-series model is limited to predict the same type of time-series data that the model has been trained on. Therefore, the constant needs to train and/or re-train a neural network model on different datasets for forecasting different types of time-series data require significant amount of computational and hardware resource.

Therefore, there is a need to improve time series data forecasting.

### BRIEF DESCRIPTION OF THE DRAWINGS

FIG. 1 provides a simplified diagram illustrating an example Transformer based time series model for forecasting various different types of time series data, according to embodiments described herein.

FIG. 2 provides a simplified diagram illustrating an example architecture of the Transformer based time series model, according to embodiments described herein.

FIG. 3 is a simplified diagram illustrating a computing device implementing the time series forecasting framework described in FIGS. 1-2, according to one embodiment described herein.

FIG. 4 is a simplified diagram illustrating the neural network structure implementing the time series forecasting module described in FIG. 3, according to some embodiments.

FIG. 5 is a simplified block diagram of a networked system suitable for implementing the time series forecasting framework described in FIGS. 1-4 and other embodiments described herein.

FIG. 6 is a simplified logic flow diagram illustrating aspects of a method of forecasting time series data for a future time period based on the Transformer based time series model illustrated in FIGS. 1-5, according to embodiments described herein.

FIG. 7 is a simplified logic flow diagram illustrating aspects of a method of training the Transformer based time series model illustrated in FIGS. 1-5, according to embodiments described herein.

FIGS. 8-11 provide example data charts illustrating example performance of the Transformer based time series model illustrated in FIGS. 1-5, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

Traditionally, time series forecasting models are usually trained on a single dataset of time-series data samples having a fixed context and prediction length. However, time-series data can often be highly heterogeneous. For example, the frequency (e.g. minutely, hourly, daily sampling rates) of time series plays an important role in determining the patterns present in the time series. For another example, dimensions of the time series data, such as multivariate time series can have different number of variates, while each variate measures a semantically different quantity across datasets (e.g., temperature, cloud, humidity, precipitation, wind speed in weather time series data). In most scenarios, these multiple variates may interact with each other in determining the patterns of the time series. Thus, for a different type of time-series data such as varying time-series context (e.g., change in the available past time window), or the prediction length (e.g., prediction time window), or different number of variates, such time series forecasting models may need to be trained and/or retrained with new time-series data.

In view of the need for an efficient time series forecasting system that accommodates different types of time series data, embodiments described herein provide a Transformer-based neural network architecture that is trained to predict different types of time series data. Specifically, a multivariate time series input may be “flattened” into a concatenation of different variate sequences as a single input sequence to the Transformer-based neural network architecture. Then a multi patch size projection layer generate patch embeddings of patches of the input sequence using different patch sizes. The patch embeddings are then passed to a Transformer self-attention layer to compute attention weights, based on which an output distribution of predicted time series data is generated.

In one embodiment, the Transformer based time series model may be built on a transformer architecture having one or more multi patch size projection layers in the encoder and the decoder, and an any-variate attention module. The Transformer based time series model may receive multivariate time series and consider all variates as a single sequence. Patches of the input are subsequently projected into vector representations via a multi patch size input projection layer. The output tokens of forecasted time series data are then decoded via the multi patch size output projection layers in the parameters of the mixture distribution.

In this way, the single Transformer based time series model may be trained on a vast collection of time series datasets of different types of times series data to perform diverse downstream forecasting tasks. Time series data of different frequencies (e.g., hourly, daily, weekly, monthly, yearly, etc.) and/or with an arbitrary number of variates for multivariate time series, and having varying distributional properties inherent in large-scale data may be combined into a single training dataset to train the single Transformer based time series model. The trained Transformer based time series model may thus be able to perform time series data forecasting for these different types of time series data without repeated retraining of the model. Computational and hardware efficiency of neural network technology in time-series data forecasting is largely improved.

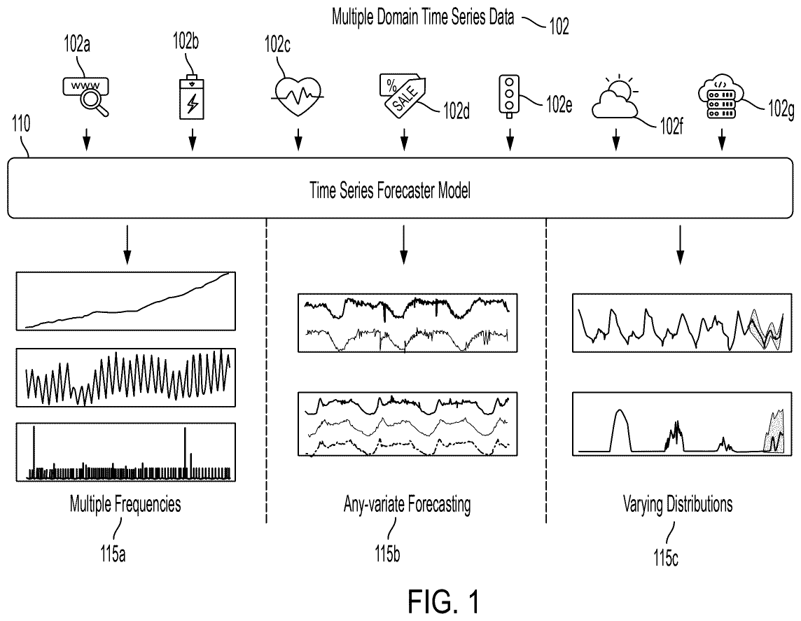

FIG. 1 provides a simplified diagram illustrating an example Transformer based time series model for forecasting various different types of time series data, according to embodiments described herein. The Transformer based time series model 110 may be a large pre-trained model trained on a large-scale time series dataset spanning multiple domains of time series data 102. For example, such multi-domain time series data 102 may comprise web activity data 102, power consumption data of an electronic device over time 102b, biometrics data over time 102c, sales data 102d, traffic data 102e, weather data 102f, processor operation data 102g, and/or the like. Such time series data from different domains 102a-g may have different frequencies, different number of variates, and may correspond to different probability distributions. Therefore, Transformer based time series model 110 may generate a predicted probability distribution of time series data over a future time window at (i) multiple frequencies 115a, ii) for any number of variates 115b, and iii) varying distributions 115c.

In one embodiment, a multi-domain time series dataset of multi-domain time series data 102 may comprise N time series

$$𝒟 = \{ ( {Y}^{( i )} , {Z}^{( i )} ) \} \begin{matrix}N \\ i = 1\end{matrix} ,$$

where Y⁽ⁱ⁾=(y₁⁽ⁱ⁾, y₂⁽ⁱ⁾, . . . , y_{T}_{ᵢ}⁽ⁱ⁾)∈ [symbol] ^{dy}^{ᵢ}^{×T}^{ᵢ} is a target time series of dyᵢ variates and Tᵢ time steps. Each time series is associated with a set of covariates Z⁽ⁱ⁾=(z₁⁽ⁱ⁾, z₂⁽ⁱ⁾, . . . , z_{T}_{ᵢ}⁽ⁱ⁾)∈ [symbol] ^{dz}^{ᵢ}^{×T}^{ᵢ}. The goal is to forecast the predictive distribution p(Y_{t:t+h}|ϕ) by predicting distribution parameters ϕ via the Transformer based time series data forecasting model 110 f_{θ}: (Y_{t-l:t}, Z_{t-l:t+h}) [symbol] \hat{ϕ}which maximizes the log-likelihood:

$${max}_{θ} {E}_{\begin{matrix}( Y , Z ) ∼ p ( 𝒟 ) \\ ( t , l , h ) ∼ p ( T \vert 𝒟 )\end{matrix}} log p ( {Y}_{t : t + h} \vert \overline{ϕ} ) , \qquad ( 1 )$$

$$s . t . {\hat{ϕ}}^{} = {f}_{θ} ( {Y}_{t - 1 : t} , {Z}_{t - l : t + h} ) ,$$

where p( [symbol] ) is the data distribution which samples for a time series, (Y, Z), and p( [symbol] | [symbol] ) is the task distribution which defines the lookback window, Y_{t-l:t}=(yₜ₋ₗ, . . . , yₜ₋₁) with context length l and forecast horizon, Y_{t:t+h}=(yₜ, . . . , yₜ₊ₕ₋₁) with prediction length h. The predicted distribution parameters ϕ may be used to generate predicted time series data distribution of different types of distributions 115c. For example, the predicted distribution parameters ϕ may be used as the mean and/or variance values for generating a Gaussian distribution, a Student's t-distribution, a negative binomial distribution, a log-normal distribution, a low variance normal distribution, and/or the like.

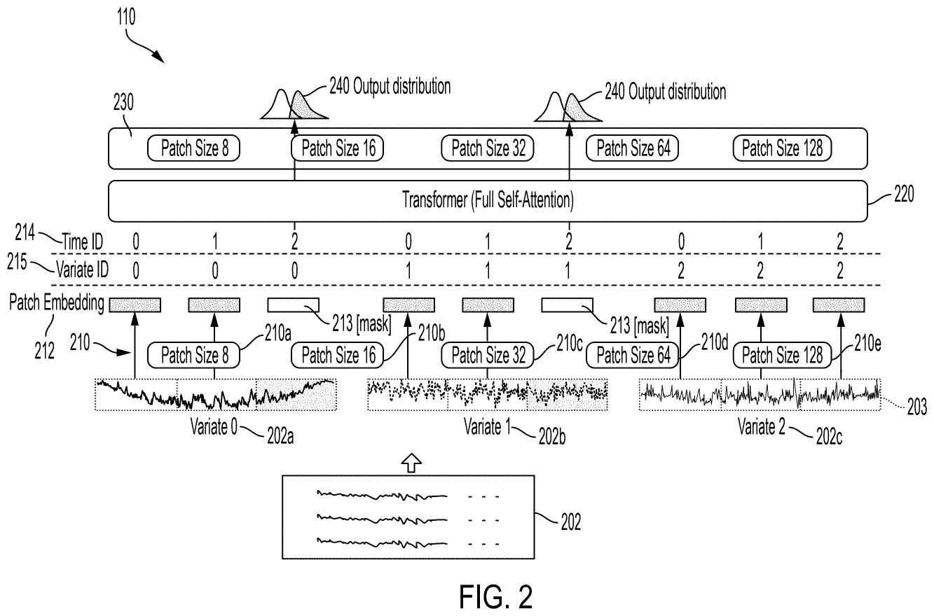

FIG. 2 provides a simplified diagram illustrating an example architecture of the Transformer based time series model 110 shown in FIG. 1, according to embodiments described herein. In one embodiment, as shown in FIG. 2, an example architecture of Transformer based time series model 110 comprises a multi-patch size input projection layer 210, a Transformer (self-attention) layer 220, and a multi-patch size output projection layer 230. Based on this architecture, Transformer based time series model 110 may adopt a non-overlapping patch-based approach to model time series with a masked encoder.

In one embodiment, the multi-patch size input projection layer 210 may encode an input of time series data spanning a wide range of frequencies and/or variates into patch embeddings 212. Specifically, a multivariate time series input 202 is “flattened” into a single sequence of all variates. For example, for a 3-variate time series input 202, where variates 0 (202a) and 1 (202b) are target variables (i.e., to be forecasted, and variate 2 (202c) is a dynamic covariate (values in forecast horizon known), the variates 202a-care flattened and concatenated into a single sequence 203.

The multi patch size input projection layer 210 may then project different sizes of patches 210a-210e into vector representations of the single sequence 203 to generate a plurality of patch embeddings 212. Specifically, instead of using a single patch size hyperparameter, different patch sizes may be selected, e.g., based on characteristics such as frequency of the time series input 202 and/or single sequence 203. For example, a larger patch size (e.g., 64, 128, etc.) may be selected for high-frequency data, thereby lower the burden of the quadratic computation cost of attention while maintaining a long context length. Or a smaller patch size (e.g., 8, 16, etc.) may be selected for low-frequency data to transfer computation to the Transformer layers 220, rather than relying solely on simple linear embedding layers.

In one embodiment, multi patch size input projection layer 210 may comprises a plurality of linear layers for input projections corresponding to multiple patch sizes. Each linear layer maps a particular patch size to hidden states, e.g., the patch embeddings 212. For example, the patch size may be selected based on the frequency of input sequence 203, based on pre-defined rules, such as:
Yearly, Quarterly: 8
Monthly: 8, 16, 32
Weekly, Daily: 16, 32
Hourly: 32, 64
Minute-level: 32, 64, 128
Second-level: 64, 128

In one embodiment, multiple embedding layers of multi patch size input projection layer 210 may be implemented to obtain the final patch embeddings 212.

As discussed above, a multivariate time series input 202 is flatted to consider all variates as a single sequence 203. The variate encodings thus would need to disambiguate between different variates 202a-c in the sequence 203. Specifically, the time identifier 214 (e.g., t=1, 2, 3, 4, . . . ) in each variate 202a-c, and the variate identifier 215 (e.g., whether variate 0, 1, or 4) associated with the patch embedding 212 may be fed to the Transformer layer 220 for attention computation.

In one embodiment, the Transformer layer 220 may be an encoder-only Transformer architecture. For example, the Transformer layer 220 may comprise a pre-normalization layer with all LayerNorms with root-mean-square normalization layer, and also apply query-key normalization. Transformer layer 220 may further comprise a feed-forward network layer with the non-linearity components replaced with SwiGLU, adjusting the hidden dimension to have equal number of parameters as the original FFN layer.

For example, given the patch embedding 212, the query and key vectors may be computed by projecting the patch embeddings 212 x having a plurality of rows indexed by the time ID 214 and a plurality of columns indexed by variate ID 215 via the respective query and key matrices W^{Q} and W^{K}. The Transformer layer 220 may compute the attention score between the (i, m)-th query where i represents the time index 214 and m represents the variate index 215, and the (j, n)-th key, A_{ij,mn}∈ [symbol] , is given by:

$${E}_{ij , mn} = {( {W}^{Q} {x}_{i , m} )}^{T} {R}_{i - j} ( {W}^{K} {x}_{j , n} ) + {u}^{( 1 )} * {\{ m = n \}}_{} + {u}^{( 2 )} * {\{ m \neq n \}}_{} , \qquad ( 2 )$$

$${A}_{i j , m n} = \frac{exp \{ {E}_{ij , mn} \}}{{\sum }_{k , o} exp \{ {E}_{ik , mo} \}} , \qquad ( 3 )$$

where W^{Q} x_{i,m}, W^{K} x_{j,n}∈ [symbol] ^{d}^{ₕ} are the respective query and key vectors, Rᵢ₋ⱼ∈ [symbol] ^{d}^{_{h×}}^{d}^{ₕ} is the rotary matrix, u⁽¹⁾, u⁽²⁾∈ [symbol] are learnable scalars for each head in each layer, and

$$\{ \begin{matrix}1 , if cond \\ 0 , otherwise\end{matrix} ,$$

is the indicator function. Thus, the binary attention bias component [symbol] ₍ₘ₌ₙ₎ allows for disambiguation between variates via attention scores, fulfills the criteria of permutation equivariance/invariance with respect to variate ordering/indices, and can extend to arbitrary number of variates.

In one embodiment, the attention score outputs from Transformer layer 220 are then passed to the multi patch size output projection layer 230 into the parameters of the mixture distribution. For example, the multi patch size output projection layer 230 may obtain the same patch size(s) selected by the multi patch size input projection layer 210 to map the attention outputs into the mixture distribution parameters, such as a mean and/or variance.

In one embodiment, to achieve a flexible distribution, while keeping operations of sampling and evaluating the loss function remains simple, a mixture of parametric distributions may be used for the output distribution 240 of the forecast time series. A mixture distribution of c components has p.d.f.:

$$p ( {Y}_{t : t + h} \vert \hat{ϕ} ) = {\sum }_{i = 1}^{c} {w}_{i} {p}_{i} ( {Y}_{t : t + h} {\hat{ϕ}}_{i} ) , \qquad ( 4 )$$

where \hat{ϕ}={w₁, \hat{ϕ}₁, . . . , w_{c}, \hat{ϕ}_{c}}, and pᵢ is the i-th component's p.d.f. For example, the output distribution 240 may comprise the following mixture components: i) a Student's t-distribution which has shown to be a robust option for general time series, ii) a negative binomial distribution for positive count data, iii) a log-normal distribution to model right-skewed data commonly across economic and natural phenomena, and iv) a low variance normal distribution for high confidence predictions.

In this case, for example, for the Student's t-distribution having a p.d.f:

$$p ( x ; v , μ , τ ) = \frac{Γ ( \frac{v + 1}{2} )}{Γ ( \frac{v}{2} ) \sqrt{π v τ}} ( 1 ⋆ \frac{1}{v} {( \frac{x - μ}{τ} )}^{- ( v + 1 ) / 2}$$

the degrees-of-freedom (df) ν>0, location μ, and scale parameters τ are predicted, and a softplus function is applied for the positivity constraint.

In another example, for the log-normal distribution has p.d.f:

$$p ( x ; μ , σ ) = \frac{1}{x σ \sqrt{2 π}} exp ( - \frac{{( ln x - μ )}^{2}}{2 {σ}^{2}} )$$

The parameters mean μ and variance σ are predicted, and a softplus function is applied for the positivity constraint.

In another example, for the negative binomial distribution having a p.d.f:

$$p ( x ; r , p ) ∝ \frac{Γ ( x + r )}{Γ ( x + 1 ) Γ ( r )} {( 1 - p )}^{r} {p}^{x}$$

Parameters r>0 and p∈[0,1] are predicted, and a softplus function is applied for positivity, and a sigmoid function to constrain to a probability.

For another example, for the low variance normal distribution having a p.d.f.:

$$p ( x ; μ , σ ) = \frac{1}{σ \sqrt{2 π}} exp ( - \frac{{( x - μ )}^{2}}{2 {σ}^{2}} ) ,$$

the mean parameter μ is predicted, and variance σ is fixed to be a small number, e.g., 1e−3, etc.

During training, a [mask] token 213 may be applied to replace patches falling within the forecast horizon such that the multi patch size input projection layer 210 may decode the mixture distribution parameters for a predicted distribution of the masked forecast horizon. In the example shown in FIG. 2 having three variates, a patch size of 64 may be selected. Thus each variate is patched into 3 tokens. The patch embeddings 212 along with sequence id 214 and variate id 215 are fed into the Transformer layer 220. The shaded patches represent the forecast horizon to be forecasted, whose corresponding output representations are mapped into the mixture distribution parameters such as a mean and/or variance. The predicted output distribution 240 corresponding to the masked forecast horizon, as generated as a mixed distribution of the predicted parameters, may be compared with the actual time series in the forecast horizon in the time series data 202, to compute a training loss, such as a cross-entropy loss. The cross-entropy loss may then be used to update the multi patch size output projection layer 230, Transformer layer 220 and multi patch size input projection layer 210, via backpropagation. For example, the scalars u⁽¹⁾, u⁽²⁾∈ [symbol] that are used in computing the attention score at each attention head in each attention layer in the Transformer layer 220 may be updated.

### Computer and Network Environment

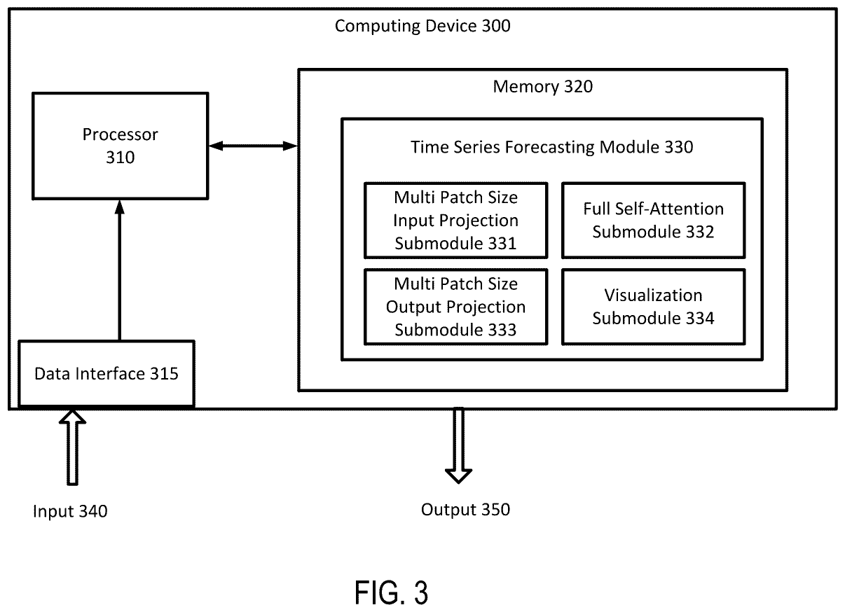

FIG. 3 is a simplified diagram illustrating a computing device implementing the time series forecasting framework described in FIGS. 1-2, according to one embodiment described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for time series forecasting module 330 that may be used to implement and/or emulate the systems and models, and/or to implement any of the methods described further herein. Time series forecasting module 330 may receive input 340 such as an input time series via the data interface 315 and generate an output 350 which may be a forecasted time series.

The data interface 315 may comprise a communication interface, a user interface (such as a voice input interface, a graphical user interface, and/or the like). For example, the computing device 300 may receive the input 340 (such as a training time series data sample) from a networked database via a communication interface. Or the computing device 300 may receive the input 340, such as a testing time series data sample, from a user via the user interface.

In some embodiments, the time series forecasting module 330 is configured to forecasted time series data. The time series forecasting module 330 may further include a Transformer structure that comprises submodules such as a multi patch size input projection submodule 331 (e.g., similar to the multi patch size input projection layer 210 in FIG. 2), a full self-attention submodule 332 (e.g., similar to the Transformer layer 220 in FIG. 2), a multi patch size output projection submodule 333 (e.g., similar to the mutli patch size input projection layer 230 in FIG. 2) and a visualization submodule 334.

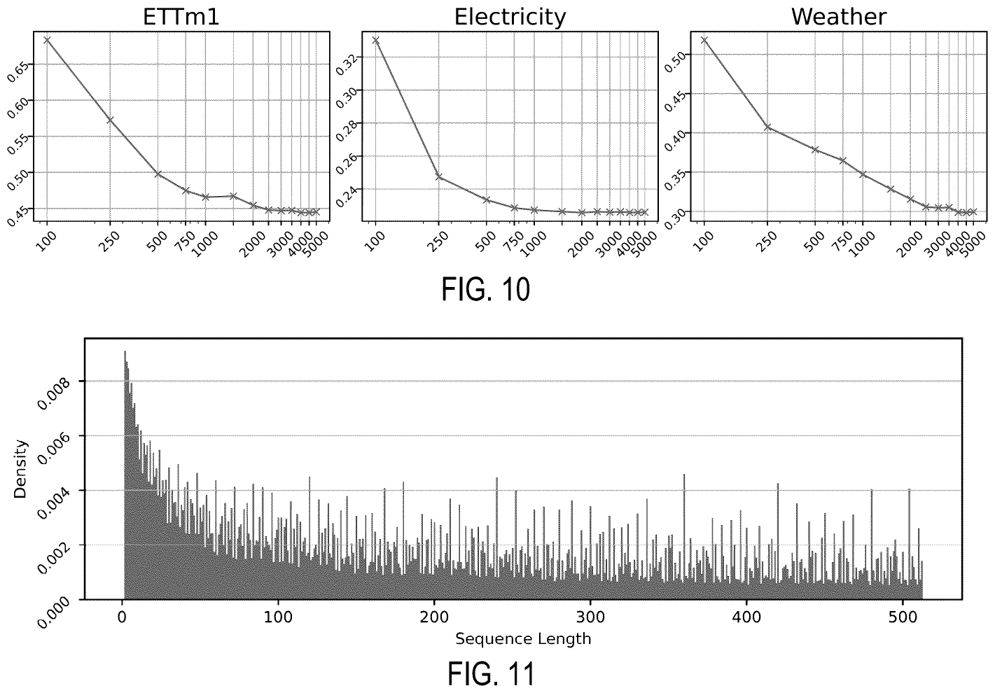

For example, multi patch size input projection submodule 331 may receive time series data (e.g., similar to 202 in FIG. 2) via data interface 315, and generate patch embeddings (e.g., similar to 212 in FIG. 2) from the input time serious data. The self-attention submodule 332 may generate attention scores for the patch embeddings from the multi patch size input projection submodule 331. The multi patch size output projection submodule 333 may then generate predicted probability distribution parameters from the attention scores from the self-attention submodule 332. The visualization submodule 334 may generate visualized time series predictions via a graphical user interface, as shown in FIGS. 10-11.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

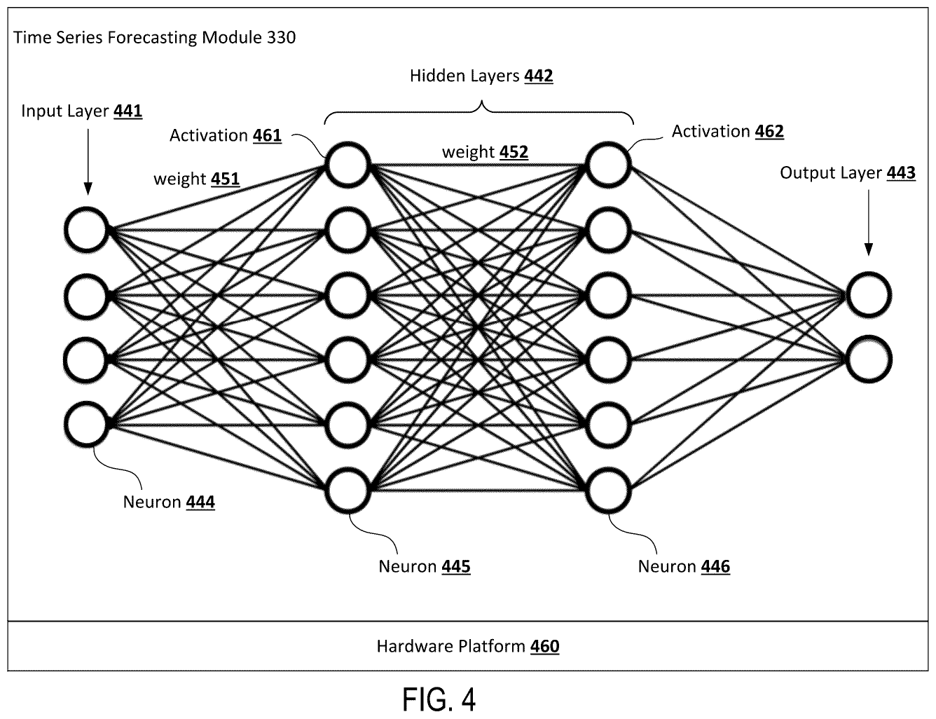

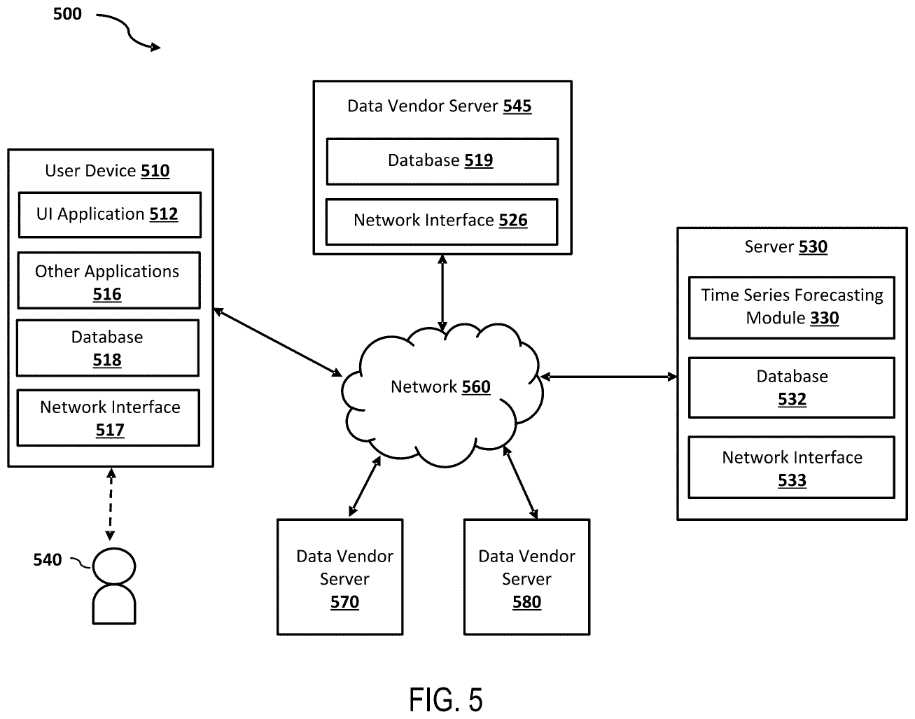

FIG. 4 is a simplified diagram illustrating the neural network structure implementing the time series forecasting module 330 described in FIG. 3, according to some embodiments. In some embodiments, the time series forecasting module 330 and/or one or more of its submodules 431-435 may be implemented at least partially via an artificial neural network structure shown in FIG. 5. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as an input image and an input text. The number of nodes (neurons) in the input layer 441 may be determined by the dimensionality of the input data (e.g., the length of a vector of a latent feature of the input image). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the time series forecasting module 330 receives an input 440 of an input image and transforms the input into an output 450 of an image representation. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the time series forecasting module 330 and/or one or more of its submodules 431-335 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer model, and/or the like.

In one embodiment, the time series forecasting module 330 and its submodules 431-335 may be implemented by hardware, software and/or a combination thereof. For example, the time series forecasting module 330 and its submodules 431-435 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based time series forecasting module 330 and one or more of its submodules 431-435 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as a training image or a training text are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth”) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as image animation.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in applications of time series data.

FIG. 5 is a simplified block diagram of a networked system 500 suitable for implementing the time series forecasting framework described in FIGS. 1-4 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive generated time series data.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating forecasted time series data from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a forecast result from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the visualized time series data.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including training images/texts to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the time series forecasting module 330 and its submodules described in FIG. 4. In some implementations, time series forecasting module 330 may receive data from database 519 at the data vendor server 545 via the network 560 to generate time series data forecasting. The generated forecast time series data may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the time series forecasting module 330. In one implementation, the database 532 may store previously generated time series data, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

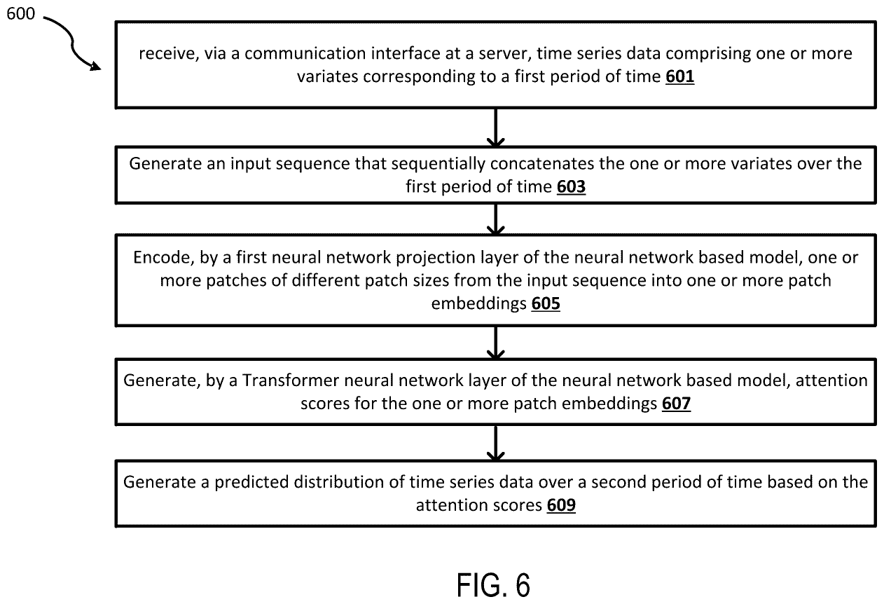

FIG. 6 is a simplified logic flow diagram illustrating aspects of a method of forecasting time series data for a future time period based on the Transformer based time series model illustrated in FIGS. 1-5, according to embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 600 corresponds to the operation of the time series module 330 (e.g., FIGS. 3 and 5).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, time series data (e.g., 202 in FIG. 2) comprising one or more variates (e.g., 202a-c in FIG. 2) corresponding to a first period of time may be received.

At step 603, an input sequence (e.g., 203 in FIG. 2) that sequentially concatenates the one or more variates over the first period of time may be generated. For example, the input sequence comprises a first subsequence corresponding to values of a first variate (e.g., 202a in FIG. 2) over the first period of time and a second subsequence concatenated to the first subsequence, corresponding to values of a second variate (e.g., 202b in FIG. 2) over the first period of time.

At step 605, a first neural network projection layer (e.g., multi patch input projection layer 210 in FIG. 2) of the neural network based model may encode one or more patches of different patch sizes from the input sequence into one or more patch embeddings (e.g., 212 in FIG. 2). For example, the patch size may be selected for the input sequence based on a frequency of the time series data.

At step 607, a Transformer neural network layer (e.g., 220 in FIG. 2) of the neural network based model may generate attention scores for the one or more patch embeddings. For example, at least one attention score may be computed between a first patch embedding corresponding to a first time index and a first variate index and a second patch embedding corresponding to a second time index and a second variate index, e.g., see Eq. (2), (3).

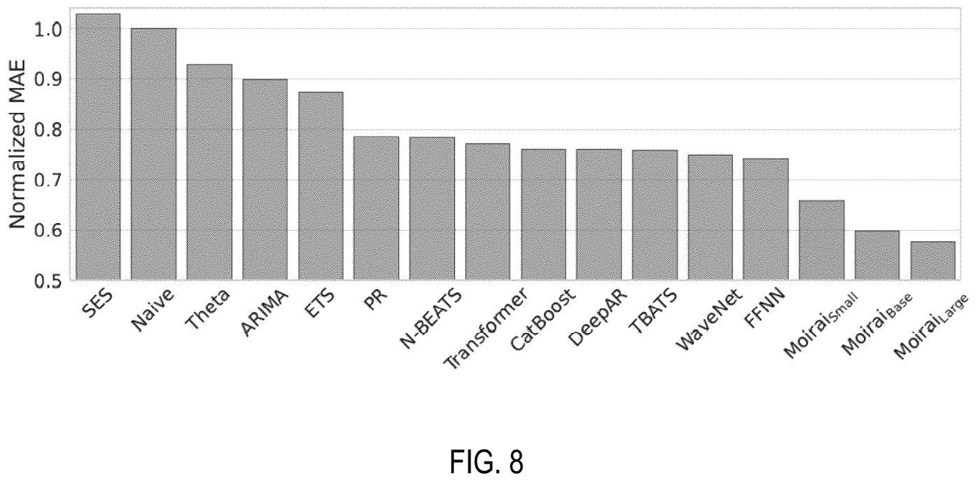

At step 609, a predicted distribution (e.g., 240 in FIG. 2) of time series data may be generated over a second period of time (e.g., the forecast window) based on the attention scores. For example, a second neural network projection layer (e.g., multi patch size output projection layer 230 in FIG. 2) of the neural network based model ma FIGS. 8-10 provide example data charts illustrating example performance of the Transformer based time series model illustrated in FIGS. 1-5, according to embodiments described herein.

y generate predicted values over the second period of time using the different patch sizes used by the first neural network projection layer (e.g., multi patch size input projection layer 210 in FIG. 2). The predicted distribution of time series data is a weighted sum of multiple distribution components parameterized by the predicted values.

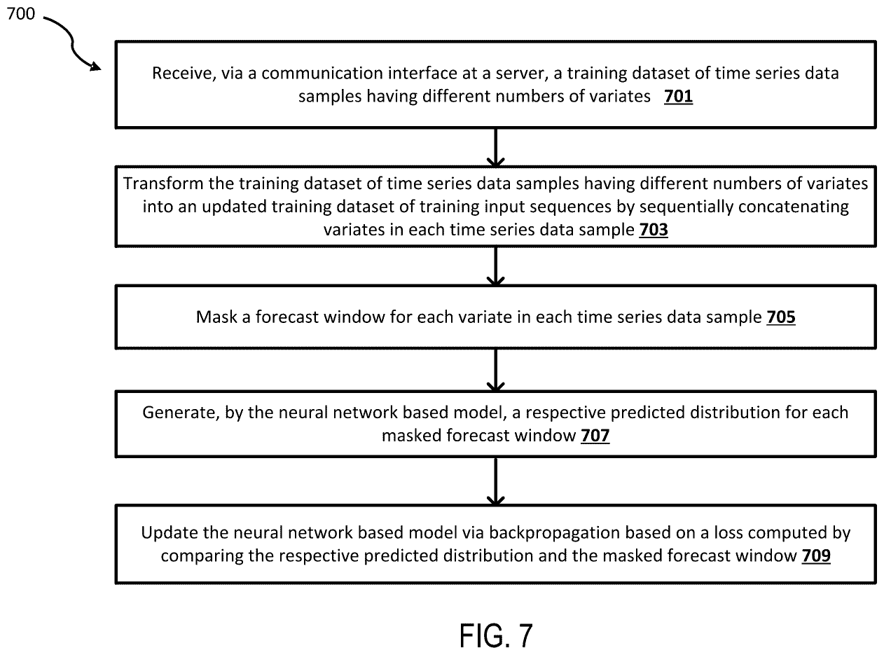

FIG. 7 is a simplified logic flow diagram illustrating aspects of a method of training the Transformer based time series model illustrated in FIGS. 1-5, according to embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the time series forecasting module 330 (e.g., FIGS. 3 and 5).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 701, a training dataset of time series data samples having different numbers of variates may be received via a communication interface (e.g., 315 in FIG. 3, or 533 in FIG. 5) at a server (e.g., 530 in FIG. 5). For example, the training dataset of time series data samples may cover a broad spectrum of domains, consolidating datasets from diverse sources with varying formats with a total of 27, 646, 462, 733 observations, with example statistics in Tables 1 and 2.

TABLE 1
Example statistics of training data by domain.

| | Energy | Transport | Climate | CloudOps | Web |
|---|---|---|---|---|---|
| # Datasets | 30 | 23 | 6 | 3 | 3 |
| # Obs. | 16,358,600,896 | 4,900,453,419 | 4,188,011,890 | 1,518,268,292 | 428,082,373 |
| % | 59.17% | 17.73% | 15.15% | 5.49% | 1.55% |

| | Sales | Nature | Econ/Fin | Healthcare |
|---|---|---|---|---|
| # Datasets | 6 | 5 | 23 | 6 |
| # Obs. | 197,984,339 | 28,547,647 | 24,919,596 | 1,594,281 |
| % | 0.72% | 0.09% | 0.10% | 0.01% |

TABLE 2
Example statistics of training data by frequency.

| | Yearly | Quarterly | Monthly | Weekly | Daily |
|---|---|---|---|---|---|
| # Datasets | 4 | 5 | 10 | 7 | 21 |
| # Obs. | 873,297 | 2,312,027 | 11,040,648 | 18,481,871 | 709,017,118 |
| % | 0.003% | 0.008% | 0.040% | 0.067% | 2.565% |

| | (Multi) | (Multi) | (Multi) |
|---|---|---|---|
| | Hourly | Minute-level | Second-level |
| # Datasets | 31 | 25 | 2 |
| # Obs. | 19,875,993,973 | 7,013,949,430 | 14,794,369 |
| % | 71.893% | 25.370% | 0.054% |

At step 703, the training dataset of time series data samples may be transformed into an updated training dataset of training input sequences by sequentially concatenating variates in each time series data sample. For example, the variates may be flattened into a single input sequence, as shown at 203 in FIG. 2.

The data distribution in the training dataset, (Y, Z)˜p( [symbol] ), defines how time series are sampled from the dataset. Specifically, sub-datasets may be obtained from the updated training dataset by decomposing the data distribution into a sub-dataset distribution, and a time series distribution conditioned on a sub-dataset, p( [symbol] )=p(Y, Z|D)p(D). Thus, a sub-dataset may first be sampled from p( [symbol] ), and given that sub-dataset, a time series training sample is sampled. Thus, for K sub-datasets, where Dₖ represents the set of indices of time series belonging to sub-dataset k, the sampling probability

$$p ( {Y}^{( i )} , {Z}^{( i )} \vert {D}_{k} ) = \frac{{T}_{i} * {\{ i ∈ {D}_{k} \}}_{}}{\sum j ∈ {D}_{k} {T}_{j}} ,$$

proportionate to the number of observations, is computed.

In another implementation, due to data imbalance across domains and frequency, instead of sampling sub-datasets proportionately, the contribution of each sub-dataset may be capped at ϵ=0.001, before re-normalizing:

$$p ( {D}_{k} ) = \frac{min ( {w}_{k} , ∈ )}{{\sum }_{i = 1}^{K} min ( {w}_{i} , ∈ )} , where {w}_{k} = \frac{\vert {D}_{k} \vert}{{\sum }_{i}^{K} \vert {D}_{i} \vert} , and \vert {D}_{k} \vert = {\sum }_{i ∈ {D}_{k}} {T}_{i} .$$

At step 705, a forecast window (e.g., 213 in FIG. 2) may be masked for each variate in each time series data sample. For example, during training, the lookback window and the forecast window may be obtained by cropping a uniformly sampled window from a pre-defined range into the lookback window and the forecast window, and a prediction length is uniformly sampled as a proportion of the forecast window.

In one implementation, sampled from a task distribution, (t, l, h)˜p(T| [symbol] ) which defines the lookback window and forecasting horizon, given a time series. In practice, rather than sampling t, l, h, given a time series, a uniformly sampled window is cropped, whose length is uniformly sampled from a range. This range is defined by a minimum sequence length per variate of 2, and a total maximum sequence length of 512. The window is then split into lookback and horizon segments, where the prediction length is uniformly sampled as a proportion (within the range [0.15, 0.5]) of the window. Training data can be further augmented by i) uniformly subsampling multivariate time series in the variate dimension, and ii) constructing multivariate time series from sub-datasets with univariate time series, by randomly concatenating them. The number of variates is sampled from a beta-binomial distribution with parameters n=128, a=2, b=5 which supports a maximum of 128 variates, with mean ≈37 for efficiency.

At step 707, the neural network based model (e.g., combining multi patch size input projection layer 210, Transformer layer 220 and multi patch size output projection layer 230) may generate a respective predicted distribution for each masked forecast window, e.g., as described in FIG. 2.

At step 709, the neural network based model may be updated via backpropagation based on a loss computed by comparing the respective predicted distribution and the masked forecast window.

In one embodiment, method 700 may be used to train the time series prediction model (e.g., 110 in FIG. 1) in three sizes—small, base, and large, as listed in Table 3. For example, the small model is trained for 100, 000 steps, while base and large models are trained for 1, 000, 000 steps with a batch size of 256. For optimization, AdamW optimizer with the following hyperparameters is implemented: Ir=1e−3, weight decay=1e−1, β1=0.9, β2=0.98. A learning rate scheduler may be applied with linear warmup for the first 10, 000 steps, and cosine annealing thereafter. Models are trained on NVIDIA A100-40G GPUS with TF32 precision.

TABLE 3
Model sizes.

| | Layers | dmodel | dff | Heads | dkv | Params | |
|---|---|---|---|---|---|---|---|
| Small | 6 | 384 | 1536 | 6 | 64 | 14 | m |
| Base | 12 | 768 | 3072 | 12 | 64 | 91 | m |
| Large | 24 | 1024 | 4096 | 16 | 64 | 311 | m |

### Example Performance

FIGS. 8-11 provide example data charts illustrating example performance of the Transformer based time series model illustrated in FIGS. 1-5, according to embodiments described herein. Example data experiments are conducted first as an in-distribution evaluation using the Monash Time Series Forecasting Archive (Godahewa et al., 2021), which aim to measure generalization capability across diverse domains. In this evaluation, a standard setting with a context length of 1000, and a patch size of 32 for all frequencies, except for quarterly data with a patch size of 8 are used. FIG. 8 summarizes the results based on the normalized mean absolute error (MAE), in comparison with the baselines presented in the Monash benchmark. It is worth noting that each baseline in the Monash benchmark is typically trained individually per dataset or per time series within a dataset. In contrast, Time series model 110 (referred to as Masked Encoder-based Universal Time Series Forecasting Transformer (MOIRAI) stands out by being a single model evaluated across various datasets.

Specifically, as shown in FIG. 8, MOIRAI outperforms all baselines from the Monash benchmark regardless of model size, displaying the strong in-distribution and cross-domain capabilities arising from our unified training methodology. It is noted that each instance of MOIRAI is a single model evaluated across datasets, compared to baselines for which one model is trained per dataset.

Example data experiments are also conducted as an out-of-distribution evaluation on unseen target datasets that have not been used to train MOIRAI. Here, MOIRAI is a zero-shot forecaster compared with baseline full-shot baselines which have been trained on the individual target datasets. For example, seven datasets are selected across energy, transport, climate, and sales domains, following a rolling evaluation setup with stride equal to prediction length. Prediction lengths and number of rolling evaluations are defined for each dataset based on frequency. Performance metrics including Continuous Ranked Probability Score (CRPS) and Mean Scaled Interval Score (MSIS) metrics, comparing against four full-shot baselines—DeepAR (Salinas et al., DeepAR: Probabilistic forecasting with autoregressive recurrent networks, International Journal of Forecasting, 36(3): 1181-1191, 2020), PatchTST (Nie et al., A time series is worth 64 words: Long-term forecasting with transformers, In proceedings of the Eleventh International Conference on Learning Representations, 2023), and TiDE (Das et al., Long-term forecasting with tiDE: Timeseries dense encoder, Transactions on Machine Learning Research, 2023, ISSN 2835-8856) with Student's t-distribution prediction heads, and TFT based on quantile prediction (Lim et al., Temporal fusion transformers for interpretable multi-horizon time series forecasting, International Journal of Forecasting, 37(4): 1748-1764, 2021), all implemented with the GluonTS library (Alexandrov et al., Gluonts: Probabilistic and neural time series modeling in python, Journal of Machine Learning Research, 21(116): 1-6, 2020), as well as simple baselines AutoARIMA (Garza et al., StatsForecast: Lightning fast forecasting with statistical and econometric models, PyCon Salt Lake City, Utah, USA, 2022), and Seasonal Naive (Hyndman et al., Forecasting: principles and practice, OTexts, 2018). For each dataset and baseline, hyperparameter tuning is performed on a validation CRPS, and report results averaged over five training runs with different seeds. For MOIRAI, inference time tuning is performed, selecting context length from {1000, 2000, 3000, 4000, 5000} and patch sizes based on frequency, on the validation CRPS.

Table 4 shows the CRPS and MSIS, compared with different baselines. MOIRAI_{Base} and MOIRAI_{Large} consistently achieve strong zero-shot performance, obtaining either best or second best results for all datasets except Walmart and Istanbul Traffic. Even for these datasets, performance is still close to the best performance, despite being a single zero-shot model compared to baselines which have been tuned and trained on the train sets.

TABLE 4
Probabilistic forecasting results. Best results are highlighted in bold, and second best results are underlined. Baseline
results are aggregated over five training runs with different seeds, reporting the mean and standard deviation.

| | | Zero-shot | | | | | | | Baseline | |
|---|---|---|---|---|---|---|---|---|---|---|
| | | MOIRAIS | MOIRAI | | Full-shot | | | | | Seasonal |
| | | mall | Base | MOIRAILarge | PatchTST | TiDE | TFT | DeepAR | AutoARIMA | Naive |
| Electricity | CRPS | 0.072 | 0.055 | 0.050 | 0.052 ± 0.00 | 0.048 ± 0.00 | 0.050 ± 0.00 | 0.065 ± 0.01 | 0.327 | 0.070 |
| | MSIS | 7.999 | 6.172 | 5.875 | 5.744 ± 0.12 | 5.6720.08 | 6.278 ± 0.24 | 6.893 ± 0.82 | 29.412 | 35.251 |
| Solar | CRPS | 0.471 | 0.419 | 0.406 | 0.518 ± 0.09 | 0.420 ± 0.00 | 0.446 ± 0.03 | 0.431 ± 0.01 | 1.055 | 0.512 |
| | MSIS | 8.425 | 7.011 | 6.250 | 8.447 ± 1.59 | 13.754 ± 0.32 | 8.057 ± 3.51 | 11.181 ± 0.67 | 25.849 | 48.130 |
| Walmart | CRPS | 0.103 | 0.093 | 0.098 | 0.082 ± 0.01 | 0.077 ± 0.00 | 0.087 ± 0.00 | 0.121 ± 0.00 | 0.124 | 0.151 |
| | MSIS | 9.371 | 8.421 | 8.520 | 6.005 ± 0.21 | 6.258 ± 0.12 | 8.718 ± 0.10 | 12.502 ± 0.03 | 9.888 | 49.458 |
| Weather | CRPS | 0.049 | 0.041 | 0.051 | 0.059 ± 0.01 | 0.054 ± 0.00 | 0.043 ± 0.00 | 0.132 ± 0.11 | 0.252 | 0.068 |
| | MSIS | 5.236 | 5.136 | 4.962 | 7.759 ± 0.49 | 8.095 ± 1.74 | 7.791 ± 0.44 | 21.651 ± 17.34 | 19.805 | 31.293 |
| Istanbul | CRPS | 0.173 | 0.116 | 0.112 | 0.112 ± 0.00 | 0.110 ± 0.01 | 0.110 ± 0.01 | 0.108 ± 0.00 | 0.589 | 0.257 |
| Traffic | MSIS | 5.937 | 4.461 | 4.277 | 3.813 ± 0.09 | 4.752 ± 0.17 | 4.057 ± 0.44 | 4.094 ± 0.31 | 16.317 | 45.473 |
| Turkey | CRPS | 0.048 | 0.040 | 0.036 | 0.054 ± 0.01 | 0.046 ± 0.01 | 0.039 ± 0.00 | 0.066 ± 0.02 | 0.116 | 0.085 |
| Power | MSIS | 7.127 | 6.766 | 6.341 | 8.978 ± 0.51 | 8.579 ± 0.52 | 7.943 ± 0.31 | 13.520 ± 1.17 | 14.863 | 36.256 |

A subset of the popular long sequence forecasting benchmark (Wu et al., Autoformer: Decomposition transformers with auto-correlation for long-term series forecasting, Advances in Neural Information Processing Systems, 34:22419-22430, 2021), omitting datasets which have datasets from the same source present in our pre-training data and cannot be considered zero-shot. The Mean Squared Error (MSE) and MAE, comparing against six state-of-the-art baselines, iTransformer (Liu et al., iTransformer: Inverted transformers are effective for time series forecasting. arXiv preprint arXiv: 2310.06625, 2023), TimesNet (Wu et al., Timesnet: Temporal 2d-variation modeling for general time series analysis, In proceedings of the Eleventh International Conference on Learning Representations, 2023), PatchTST, Crossformer (Zhang et al., Crossformer: Transformer utilizing cross-dimension dependency for multivariate time series forecasting, In proceedings of the Eleventh International Conference on Learning Representations, 2023), TiDE, DLinear (Zeng et al., Are transformers effective for time series forecasting? In Proceedings of the AAAI conference on artificial intelligence, volume 37, pp. 11121-11128, 2023), SCINet (Liu et al., SciNET: Time series modeling and forecasting with sample convolution and interaction. Advances in Neural Information Processing Systems, 35:5816-5828, 2022), and FEDformer (Zhou et al., FEDformer: Frequency enhanced decomposed transformer for long-term series forecasting, in Proc. 39^{th} International Conference on Machine Learning (ICML 2022)). Point forecasts are obtained from MOIRAI by taking the median from the samples of the predictive distribution. Tuning for MOIRAI was based on the average validation MSE across prediction lengths, further including the options between channel independent and channel mixing strategies (Nie et al., 2023) for the low dimension datasets (ETT and Weather).

Table 5 shows the average performance across prediction lengths. MOIRAI achieves strong results compared to full-shot baselines.

TABLE 5
Long sequence forecasting results. Results are averaged across prediction lengths {96,
192, 336, 720}. Best results are highlighted in bold, and second best results are underlined.

| | | Zero-shot | | | Full-shot | | | | | | | |
|---|---|---|---|---|---|---|---|---|---|---|---|---|
| | | MOIRA [symbol] | MOIRA [symbol] | MOIRA [symbol] | [symbol] Transformer | TimesNet | PatchTST | Crossformer | TiDE | D [symbol] near | SCINet | FEDformer |
| ETTh1 | MSE | 0.400 | 0.434 | 0.510 | 0.454 | 0.458 | 0.469 | 0.529 | 0.541 | 0.456 | 0.747 | 0.44 |
| | MAE | 0.424 | 0.438 | 0.469 | 0.448 | 0.450 | 0.455 | 0.522 | 0.507 | 0.452 | 0.647 | 0.46 |
| ETTh2 | MSE | 0.341 | 0.345 | 0.354 | 0.383 | 0.414 | 0.387 | 0.942 | 0.611 | 0.559 | 0.954 | 0.437 |
| | MAE | 0.379 | 0.382 | 0.376 | 0.407 | 0.497 | 0.407 | 0.684 | 0.550 | 0.515 | 0.723 | 0.449 |
| ETTm1 | MSE | 0.448 | 0.381 | 0.390 | 0.407 | 0.400 | 0.387 | 0.513 | 0.419 | 0.403 | 0.486 | 0.448 |
| | MAE | 0.409 | 8.388 | 0.389 | 0.410 | 0.406 | 0.400 | 0.495 | 0.419 | 0.407 | 0.481 | 0.452 |
| ETTm2 | MSE | 0.300 | 0.272 | 0.276 | 0.288 | 0.291 | 0.281 | 0.757 | 0.358 | 0.35 | 0.571 | 0.305 |
| | MAE | 0.341 | 0.321 | 0.320 | 0.332 | 0.333 | 0.326 | 0.611 | 0.404 | 0.401 | 0.537 | 0.349 |
| Electricity | MSE | 0.233 | 0. [symbol] 88 | 0.188 | 0.178 | 0. [symbol] 93 | 0.216 | 0.244 | 0.252 | 0.212 | 0.268 | 0.214 |
| | MAE | 0.320 | 0.274 | 0.273 | 0.270 | 0.295 | 0.3 [symbol] 4 | 0.334 | 0.344 | 0.3 | 0.365 | 0.327 |
| Weather | MSE | 0.242 | 0.238 | 0.259 | 0.258 | 0.259 | 0.259 | 0.259 | 0.271 | 0.265 | 0.292 | 0.309 |
| | MAE | 0.267 | 0.261 | 0.275 | 0.278 | 0.287 | 0.281 | 0.315 | 0.320 | 0.317 | 0.363 | 0.36 |

[symbol]

indicates data missing or illegible when filed

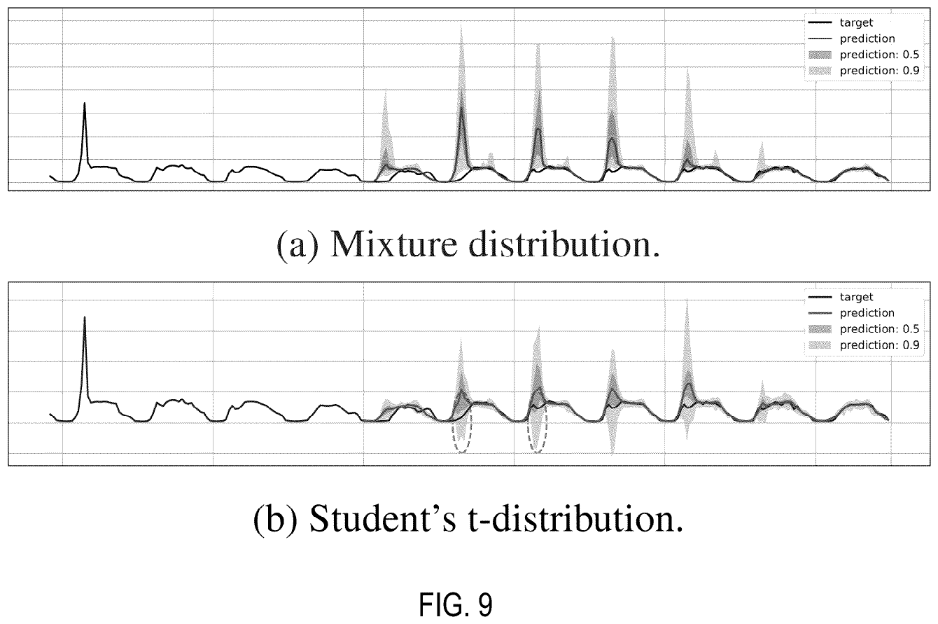

FIGS. 9-11 provide example visualization of time series data prediction. For example, FIG. 9 shows a visualization of probabilistic forecasts by two variants of MOIRAISmall on the Traffic Hourly dataset. Both models forecast peaks, however, the Student's t-distribution has a symmetric distribution, giving inappropriate prediction intervals for a peak.

FIG. 10 shows example plots of performance (MAE) against context length (x-axis in log scale) with prediction length 96 and patch size 32 on the validation set of the ETTm1, Electricity, and Weather datasets. It is shown that MOIRAI has the capability to take as input arbitrary context lengths by visualizing the relationship between performance and increasing context lengths over three datasets in the zero-shot setting.

FIG. 11 shows a histogram of sequence length when sampling data from training data based on the proposed task distribution. Sequence length refers to the number of tokens after patching and flattening.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of forecasting time series data for a future time period by a neural network based model, the method comprising:
receiving time series data comprising one or more variates corresponding to a first period of time;
generating an input sequence that sequentially concatenates the one or more variates over the first period of time;
encoding, by a first neural network projection layer of the neural network based model, one or more patches of different patch sizes from the input sequence into one or more patch embeddings;
generating, by a Transformer neural network layer of the neural network based model, attention scores for the one or more patch embeddings; and
generating a predicted distribution of time series data over a second period of time based on the attention scores.

2. The method of claim 1, wherein the input sequence comprises a first subsequence corresponding to values of a first variate over the first period of time and a second subsequence concatenated to the first subsequence, corresponding to values of a second variate over the first period of time.

3. The method of claim 1, wherein the encoding the one or more patches of different patch sizes further comprises:
selecting a patch size for the input sequence based on a frequency of the time series data.

4. The method of claim 1, wherein the generating the attention scores for the one or more patch embeddings comprises:
computing at least one attention score between a first patch embedding corresponding to a first time index and a first variate index and a second patch embedding corresponding to a second time index and a second variate index.

5. The method of claim 4, wherein the at least one attention score is computed based at least in part on two learnable weights of the Transformer neural network layer depending on whether the first variate index equals the second variate index.

6. The method of claim 1, further comprising:
generating, by a second neural network projection layer of the neural network based model, predicted values over the second period of time using the different patch sizes used by the first neural network projection layer.

7. The method of claim 6, wherein the predicted distribution of time series data is a weighted sum of multiple distribution components parameterized by the predicted values.

8. The method of claim 1, further comprising:
transforming a training dataset of time series data samples having different numbers of variates into an updated training dataset of training input sequences,
wherein each training input sequence sequentially concatenates variates in a respective time series data sample; and
training the neural network based model using the updated training dataset of training input sequences.

9. The method of claim 8, wherein the training the neural network based model further comprises:
masking a forecast window for each variate in each time series data sample;
generating, by the neural network based model, a respective predicted distribution for each masked forecast window; and
updating the neural network based model via backpropagation based on a loss computed by comparing the respective predicted distribution and the masked forecast window.

10. The method of claim 8, further comprising:
obtaining a lookback window and the forecast window by cropping a uniformly sampled window from a pre-defined range into the lookback window and the forecast window,
wherein a prediction length is uniformly sampled as a proportion of the forecast window.

11. A system of forecasting time series data for a future time period by a neural network based model, the system comprising:
a communication interface that receives time series data comprising one or more variates corresponding to a first period of time;
a memory storing a plurality of processor-executed instructions; and
one or more processors executing the plurality of processor-executed instructions to perform operations comprising:
generating an input sequence that sequentially concatenates the one or more variates over the first period of time;
encoding, by a first neural network projection layer of the neural network based model, one or more patches of different patch sizes from the input sequence into one or more patch embeddings;
generating, by a Transformer neural network layer of the neural network based model, attention scores for the one or more patch embeddings; and
generating a predicted distribution of time series data over a second period of time based on the attention scores.

12. The system of claim 11, wherein the input sequence comprises a first subsequence corresponding to values of a first variate over the first period of time and a second subsequence concatenated to the first subsequence, corresponding to values of a second variate over the first period of time.

13. The system of claim 11, wherein the operation of encoding the one or more patches of different patch sizes further comprises:
selecting a patch size for the input sequence based on a frequency of the time series data.

14. The system of claim 11, wherein the operation of generating the attention scores for the one or more patch embeddings comprises:
computing at least one attention score between a first patch embedding corresponding to a first time index and a first variate index and a second patch embedding corresponding to a second time index and a second variate index.

15. The system of claim 14, wherein the at least one attention score is computed based at least in part on two learnable weights of the Transformer neural network layer depending on whether the first variate index equals the second variate index.

16. The system of claim 11, wherein the operations further comprise:
generating, by a second neural network projection layer of the neural network based model, predicted values over the second period of time using the different patch sizes used by the first neural network projection layer.

17. The system of claim 16, wherein the predicted distribution of time series data is a weighted sum of multiple distribution components parameterized by the predicted values.

18. The system of claim 11, wherein the operations further comprise:
transforming a training dataset of time series data samples having different numbers of variates into an updated training dataset of training input sequences,
wherein each training input sequence sequentially concatenates variates in a respective time series data sample; and
training the neural network based model using the updated training dataset of training input sequences.

19. The system of claim 18, wherein the operation of training the neural network based model further comprises:
masking a forecast window for each variate in each time series data sample;
generating, by the neural network based model, a respective predicted distribution for each masked forecast window; and
updating the neural network based model via backpropagation based on a loss computed by comparing the respective predicted distribution and the masked forecast window.

20. A non-transitory processor-readable storage medium storing a plurality of processor-executable instructions for forecasting time series data for a future time period by a neural network based model, the instructions being executed by one or more processors to perform operations comprising:
receiving time series data comprising one or more variates corresponding to a first period of time;
generating an input sequence that sequentially concatenates the one or more variates over the first period of time;
encoding, by a first neural network projection layer of the neural network based model, one or more patches of different patch sizes from the input sequence into one or more patch embeddings;
generating, by a Transformer neural network layer of the neural network based model, attention scores for the one or more patch embeddings; and
generating a predicted distribution of time series data over a second period of time based on the attention scores.
